(19) United States
(12) Patent Application Publication
(10) Pub. No.: US 2004/0034701 A1
(43) Pub. Date: Feb. 19, 2004

(54) Watchdog termination in a communication system

(75) Inventor: David J. Kasper II, Aliso Viejo, CA (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/218,346

(22) Filed: Aug. 14, 2002

(51) Int. Cl. G06F 15/173

(52) U.S. Cl. 709/224

(57) ABSTRACT

A watchdog monitors and terminates applications that have been initiated through a data link between a local unit and a remote unit. A data link session is established between the local and remote units. When the status of the data link indicates that the link has been lost, the watchdog process terminates the applications initiated by the remote unit.

### TECHNICAL FIELD

The present invention relates generally to data communications and particularly to terminating high-level communication applications.

### BACKGROUND

A typical communication system is made up of a local computer (i.e., at a central office) that has a modem for communicating over the public switched telephone network (PSTN) with a specific remote computer (i.e., at a customer site) that also has a modem. When a remote user desires to initiate a data link session with the local computer, he typically logs on to the system with a user identification and/or password. This information is then transmitted to the local computer over a physical layer for authentication. After the information has been authenticated, handshaking is performed in order to activate a data link session.

Once the data link session has been established, the remote user can initiate applications on the local computer over the data link. For example, the user may initiate a graphical user interface (GUI) or other such high level application.

A problem exists if the data link session goes down, such as when the connection is lost and/or the digital signal processors at the data link layer lose convergence. The remote user is still logged on to the local computer with the high-level application running. If the original remote user leaves the remote computer and the data link session subsequently recovers, anyone who later uses the same remote computer is now logged on as the original remote user. This creates a security problem when the new user is allowed access to the original remote user's applications and data. There is a resulting need in the art for a way to terminate the high-level application on the local computer after a connection is lost.

### SUMMARY

The embodiments of the present invention encompass a method for watchdog termination of an application in a communication system. The communication system is comprised of a local unit and a remote unit. A data link session is established between the local and remote units. A status indicator of the data link session is checked for an offline or online condition. If the status indicator indicates an offline status for the data link session, execution of the application is terminated.

### BRIEF DESCRIPTION OF THE DRAWINGS

FIG. 1 shows a flowchart of one embodiment of the watchdog method of the present invention.

FIG. 2 shows a flowchart of one embodiment of a status determination method of the present invention.

FIG. 3 shows a block diagram of one embodiment of a communication system in accordance with the synchronization method of the present invention.

FIG. 4 shows a block diagram of one embodiment of a management card in accordance with the synchronization method of the present invention.

FIG. 5 shows a block diagram of one embodiment of a line card in accordance with the synchronization method of the present invention.

### DETAILED DESCRIPTION

The embodiments of the present invention provide a way to terminate high-level applications on a central office computer after a connection has been lost. This is accomplished by a watchdog method that monitors the status of the connection and aborts or terminates the high-level applications when the status indicates an offline condition.

At least one embodiment of the method of the present invention relates to the data link layer. It is well known in the art that this layer sits just above the physical layer. It defines the protocols that directly interact with the physical components of the link such as network adapters and modems. This layer is responsible for framing data and controlling the flow of information across the link using various protocols (e.g., point-to-point, link access, and serial line interface).

The subsequent discussion of the embodiments of the present invention refers to using remote computers to log on to central office computers. The embodiments of the present invention are not limited to computers. The embodiments of the present invention encompass any remote unit that is capable of having a data link session with a local unit. For example, a simple terminal, with only the ability to transmit, receive, and display data, may be used in place of the remote computer to initiate the data session with the central office's local computer.

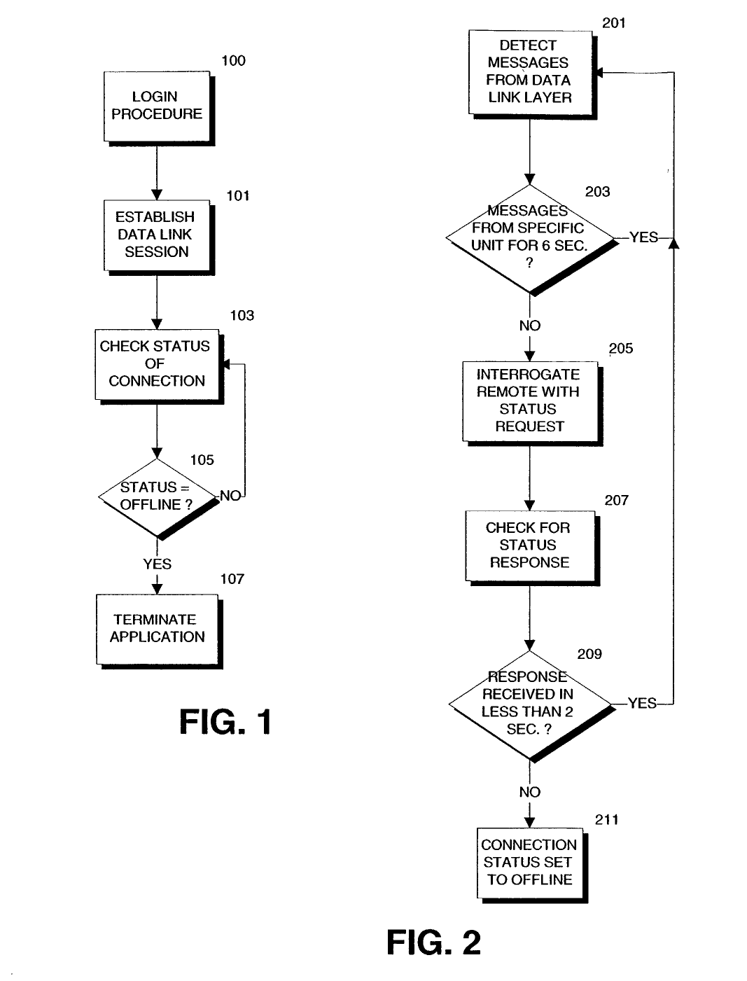

FIG. 1 illustrates a flowchart of one embodiment of a watchdog method of the present invention. A login procedure (100) is initiated when the remote computer user desires a data link session with the local computer at the central office. This procedure entails the local computer receiving a request for a data link session and requesting the remote computer user to input a user identification and/or a password that uniquely identifies that user. The login procedure (100) may be initiated by the remote computer prior to transmitting data to the local computer or it may be initiated by the local computer that is replying to a login request from the remote computer or terminal.

A data link session is established (101) after the user identification and/or password has been received and authenticated by either the local or remote computers, depending on which initiated the procedure. As is well known in the art, the data link session is established (101) after transmission and acceptance of control words over the physical layer. The process used to establish the data link session is not discussed further since the control words required to establish the session depend upon the protocols for a certain type of network. The embodiments of the present invention are not limited to any one network or protocol.

Once the data link session is established, the remote user can initiate and/or control various processes on the local computer. For example, the remote user can initiate high-level applications such as a graphical user interface. High-level applications also include system control processes or any other type of application or process that executes other applications or processes.

After the data link session is established, a status indicator of the connection is checked (103) to determine if the data link session is still active. One embodiment of a method for determining the data link session status is discussed subsequently in greater detail.

If the status indicates that the connection is not offline (105), the status is continually checked until it is determined that it indicates an offline condition. If the status indicates that the connection is offline (105), high level applications executed by the local computer are terminated (107). Once the high level applications have been terminated, if a data link session is reestablished between the remote computer and the local computer, a new login procedure is required to enable access to the remote computer.

In an alternate embodiment, the method of the present invention terminates lower level applications as well as the high level applications. The low level applications include the applications and processes (e.g., communication processes) that are executed by the high level applications.

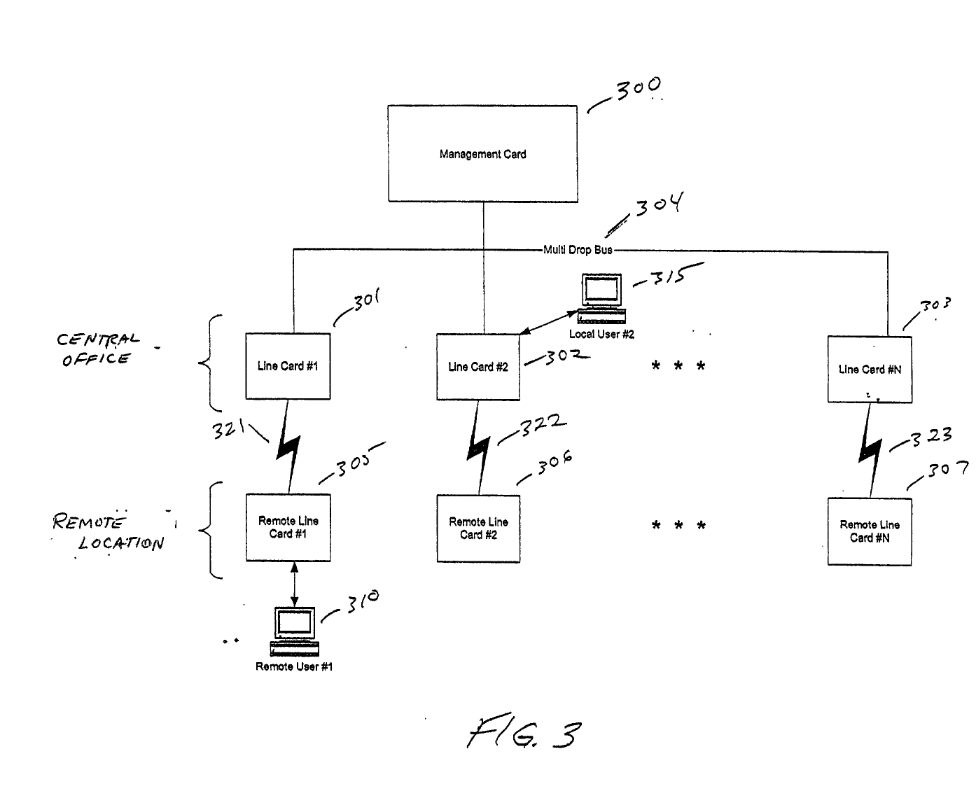

FIG. 2 illustrates a flowchart of one embodiment of a data link status determination method of the present invention. The method detects messages between the remote and local computers over the data link layer (201). If a message is not detected from a specific remote computer for a time period that is greater than a selected period of time (203), the specific remote computer is interrogated with a status request message (205). The selected time period, in one embodiment, is six seconds. Other embodiments use other time periods.

In one embodiment, the status request message is a control word transmitted from the local computer to the remote computer instructing the remote computer to respond with its status (e.g., executing, locked, sleeping). Alternate embodiments use multiple controls words as a status request message.

The local computer then checks for a response from the remote computer (207). The response, in one embodiment, is in the form of a control word indicating the remote computer's status. Alternate embodiments use multiple words as the response.

If the response is received in less than a selected response time period (209), it is assumed that the data link session is still active and the status checking continues. In one embodiment, the selected response time period is two seconds. Other embodiments use other response time periods.

If the response is not received within the selected response time (209), the remote computer is declared to be offline (211). The status indicator is set as offline. Such a status, in one embodiment, is logged in the local computer or a management card of the system for future use. As discussed above, when the status indicator is set as offline, the applications initiated by the remote user are terminated.

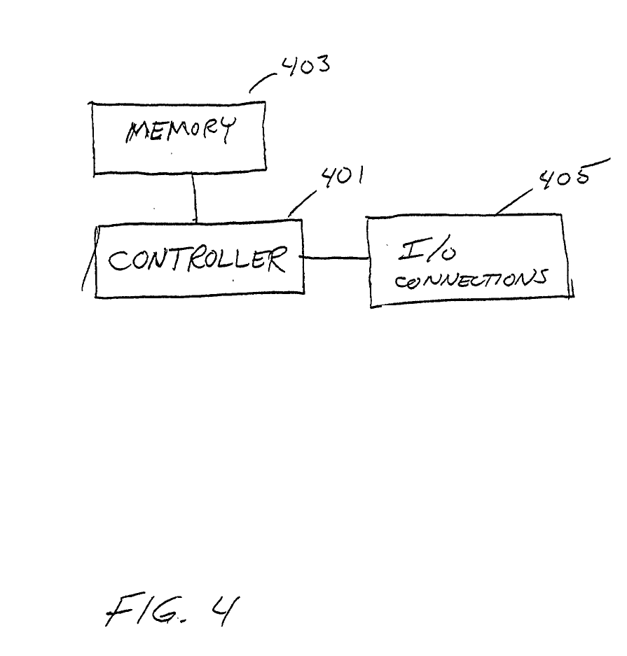

FIG. 3 illustrates a block diagram of a communication system in accordance with the watchdog method of the present invention. The system of FIG. 3 is for illustration purposes only and does not limit the watchdog method to this particular system.

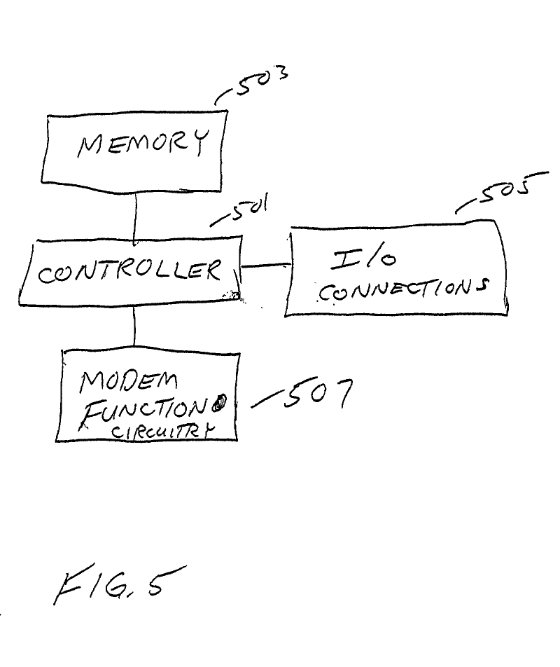

This system includes a management card (300) that is responsible for controlling the system of the present invention. In one embodiment, the management card (300) executes the methods of the present invention such as one or more of the embodiments described above with respect to FIGS. 1 and 2. One embodiment of the management card (300) is described subsequently with reference to FIG. 4.

Line cards 1−N (301-303) are coupled to the management card (300) through a multi-drop bus or backplane (304). In the communication system embodiment, line cards 1−N (301-303) are modems that support data services that are provided to customers. In an alternate embodiment, the line cards (301-303) execute the methods of the present invention.

Each line card (301-303) is coupled to a communication link (321-323 respectively). The communication link may be a T1 line, a DSL line, a wireless link, an optical link, or any other form of communication link depending on the type of data services provided by each line card. Embodiments of communication systems according to the present invention are not limited to any one form of communication link.

The communication links (321-323) couple their respective line card to a remote line card (305-307) that is located at the customer's site. In one embodiment, the remote line cards 1−N (305-307) are the same type of modem as the respective line card to which it is coupled. In other words, if line card 1 (301) is a DSL modem, remote terminal 1 (305) is a DSL modem. In another embodiment, the remote line cards (305-307) are able to communicate using multiple communication standards.

The remote computer (310) is coupled to at least one of the remote line cards (305-307). The remote computer (310) can then communicate over its communication link (321) with the network to which the system is connected.

The local computer (315) is coupled to one or more of line cards 1−N (301-303). The local computer (315) enables a computer operator at the central office to interface with the system for maintenance and operation of the system.

The execution of the various embodiments of the methods described above with respect to FIGS. 1 and 2 of the present invention is not limited to any one unit in the communication system of FIG. 3. In various embodiments, the methods are executed in the local computer, the line card used by the local computer, or the system management card.

FIG. 4 illustrates a block diagram of one embodiment of a management card of the present invention. In this embodiment, the management card has a controller (401) that controls the operation of the management card as well as the operation of the communication system. The controller (401) may be a microprocessor, a microcontroller, or some other form of control circuitry. In one embodiment, the controller (401) executes the embodiments of the watchdog method of the present invention.

Memory (403) is coupled to the controller (401) to store data for use by the controller (401). The memory (403) can be any type of memory such as semiconductor, magnetic, or optical.

Input/Output (I/O) connections (405) enable the controller (401) to communicate with the other cards of the system. The I/O connections (405) include circuit card contacts such as connectors, circuit card fingers, or other types of connections.

FIG. 5 illustrates a block diagram of one embodiment of a line card of the present invention. In this embodiment, the line card has a controller (501) that controls the operation of the line card communication circuitry. The controller (501) is a microprocessor, a microcontroller, or some other form of control circuitry. In one embodiment, the controller (501) executes the embodiments of the watchdog method of the present invention.

Memory (503) is coupled to the controller (501) to store data for use by the controller (501). The memory (503) can be any type of memory such as semiconductor, magnetic, or optical.

Input/Output (I/O) connections (505) enable the line card to communicate with the management card as well as other cards of the system. In one embodiment, the I/O connections (505) include circuit card contacts such as connectors, circuit card fingers, or other types of connections.

Modem function circuitry (507) provides the line card with the ability to communicate over communication links with other modems. Modem operation is well known in the art and is not discussed further. The modem function circuitry (507) is coupled to the controller (501) and enables the local communication system to communicate over the communication links with remote modems that are coupled to computers.

In summary, the embodiments of the watchdog termination method of the present invention provide an extra layer of security to a communication system. When a data link session is lost, the applications initiated by the original remote terminal user are terminated. A subsequent user of the remote terminal must then perform another login procedure after the data link session is reestablished. This prevents the subsequent user from accessing applications and data from the original data link session.

Numerous modifications and variations of the present invention are possible in light of the above teachings. It is therefore to be understood that within the scope of the appended claims, the invention may be practiced otherwise than as specifically described herein.

What is claimed is:

1. A method for watchdog abort of an application in a communication system having a local unit and a remote unit, the method comprising:
establishing a data link session between the local unit and the remote unit;
checking a status indicator of the data link session; and
if the status indicator indicates an offline status for the data link session, terminating execution of the application.

2. The method of claim 1 wherein establishing a data link session further comprises:
requesting the data link session;
initiating a login procedure; and
responding to the login procedure with a user identification.

3. The method of claim 1 wherein the application is a high-level application.

4. The method of claim 3 wherein the high-level application is a graphical user interface.

5. The method of claim 1 wherein the local unit and remote unit are coupled to a local line card and remote line card respectively and the data link session is established over a communication link between the local line card and the remote line card.

6. The method of claim 1 and further including generating the status indicator by:
detecting messages over the data link session;
if a message is not detected over the data link session for a selected time, interrogating with a status request; and
if a response to the status request is not received within a selected response time, indicating an offline status.

7. A method for watchdog abort of an application in a communication system having a local computer and a remote computer, the method comprising:
establishing a data link session between the local computer and the remote computer;
checking a status indicator of the data link session; and
if the status indicator indicates an offline status for the data link session, terminating execution of the application.

8. The method of claim 7 and further including:
the remote computer requesting the data link session;
the local computer initiating a login procedure; and
the remote computer responding to the login procedure with a user identification.

9. The method of claim 8 wherein the application is executed by the local computer and is initiated by the remote computer.

10. A method for watchdog abort of an application in a communication system having a local computer and a remote computer, the method comprising:
receiving a request for a data link session between the local computer and the remote computer;
establishing the data link session between the local computer and the remote computer;
checking a status indicator of the data link session; and
if the status indicator indicates an offline status for the data link session, terminating execution of the application.

11. The method of claim 10 wherein establishing the data link session further comprises:
transmitting a login procedure; and
receiving a response to the login procedure.

12. The method of claim 11 wherein receiving the response comprises receiving a user identification or a password.

13. The method of claim 11 wherein receiving the response comprises receiving a user identification and a password.

14. A method for watchdog abort of an application in a communication system having a local computer and a remote computer, the method comprising:
receiving a request for a data link session between the local computer and the remote computer;
establishing the data link session between the local computer and the remote computer;
detecting messages over the data link session;
if a message is not detected over the data link session for a selected time, interrogating with a status request;
if a response to the status request is not received within a selected response time, indicating an offline status; and
if the status indicator indicates the offline status for the data link session, terminating execution of the application.

15. A method for watchdog abort of an application in a communication system having a local computer and a remote computer, the method comprising:
transmitting a request for a data link session between the local computer and the remote computer;
establishing the data link session between the local computer and the remote computer;
checking a status indicator of the data link session; and
if the status indicator indicates an offline status for the data link session, terminating execution of the application.

16. A communication system comprising:
a plurality of local line cards that communicate over a communication link using a selected communication standard;
a local computer, coupled to at least one of the plurality of local line cards, that generates data for transmission over the communication link using the at least one local line card, the local computer executing an application; and
a management card that controls operation of the plurality of local line cards, the management card capable of executing a method comprising:
establishing a data link session over the communication link between the local computer and a remote unit;
checking a status indicator of the data link session; and
if the status indicator indicates an offline status for the data link session, terminating execution of the application.

17. The system of claim 16 wherein the remote unit is a remote computer.

18. A communication system comprising:
a plurality of local line cards that communicate over a communication link using a selected communication standard, at least one of the plurality of local line cards capable of executing a method comprising:
establishing a data link session over the communication link with a remote unit;
checking a status indicator of the data link session; and
if the status indicator indicates an offline status for the data link session, terminating execution of the application;
a local computer, coupled to at least one of the plurality of local line cards, that generates data for transmission over the communication link using the at least one local line card, the local computer executing an application; and
a management card that controls operation of the plurality of local line cards.

19. The system of claim 18 wherein the at least one local line card comprises a digital subscriber line modem and the communication link comprises a digital subscriber line connection.

20. The system of claim 18 wherein the remote unit is a remote computer that initiates the data link session.
